(19) United States
(12) Patent Application Publication
(10) Pub. No.: US 2002/0128921 A1
(43) Pub. Date: Sep. 12, 2002

(54) System and method for facilitating electronic purchasing

(76) Inventor: Lorin A. Tarr, Atlanta, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 09/810,968

(22) Filed: Mar. 16, 2001

Related U.S. Application Data
(60) Provisional application No. 60/189,753, filed on Mar. 16, 2000.

(51) Int. Cl. G06F 17/60

(52) U.S. Cl. 705/26

(57) ABSTRACT

A system and method facilitate electronic purchasing of an item selected for purchase. An available credit limit for the user is determined based upon a user account into which finds are periodically automatically deposited. The user account may be a payroll. The price of the selected item is determined and compared with the available credit limit. If the price is less than or equal to the available credit limit, the price is deducted from the available credit limit. Funds are automatically deducted from the user account at prescribed periods, until the amount of the price has been deducted. As funds are deducted from the user account, the amount of the deducted funds is added to the available credit limit. The available credit limit may also be determined based upon a charge account, and the user may designate whether to purchase the item using periodic deductions from the user account or by charging the price to the charge account. If the user designates to purchase the item by charging the price to the charge account, the price is deducted from the available credit limit. Upon payment by the user to the charge account, the amount of the payment is added to the available credit limit.

### BACKGROUND

The present invention relates generally to electronic commerce, and more particularly, to a system and method for facilitating electronic purchasing.

### SUMMARY

According to exemplary embodiments, a system and a method are provided for facilitating electronic purchasing. An item is selected for purchase by a user at a user interface.

According to one embodiment, an available credit limit for the user is determined based upon a user account into which finds are periodically automatically deposited. The user account may be, for example, a payroll, in which case the funds are automatically deducted from the payroll at each pay period for a predetermined number of pay periods. The price of the selected item is determined and compared with the available credit limit. If the price is less than or equal to the available credit limit, the price is deducted from the available credit limit. Funds are automatically deducted from the user account at prescribed periods, until the amount of the price has been deducted. As funds are deducted from the user account, the amount of the deducted funds is added to the available credit limit.

According to another embodiment, the available credit may also be determined based upon a charge account, and the user may designate whether to purchase the item using periodic deductions from the user account or by charging the price to the charge account. If the user designates to purchase the item by charging the price to the charge account, the price is deducted from the available credit limit. Upon payment by the user to the charge account, the amount of the payment is added to the available credit limit.

According to exemplary embodiments, an inventory is managed as items are purchased. The item may be a contribution, good, or service. The user interface may be a kiosk or a personal computer. The steps may be performed by a web server connected to the user interface via the Internet.

The system and method may be applicable to any number of users, each user having an individual user account, an individual charge account, and an individual available credit limit.

### BRIEF DESCRIPTION OF THE DRAWINGS

FIGS. 1-13 illustrate an exemplary embodiment of the system and method for facilitating automated payroll deduction.

### DETAILED DESCRIPTION

According to exemplary embodiments, a network such as the Internet is used to offer a wider array of products and services on a 24-hour, 365-day per year basis to users such as the employees of hospitals, corporations, labor unions and other affinity groups for revenue or for fundraising. Most of these employees have no credit and no computer access.

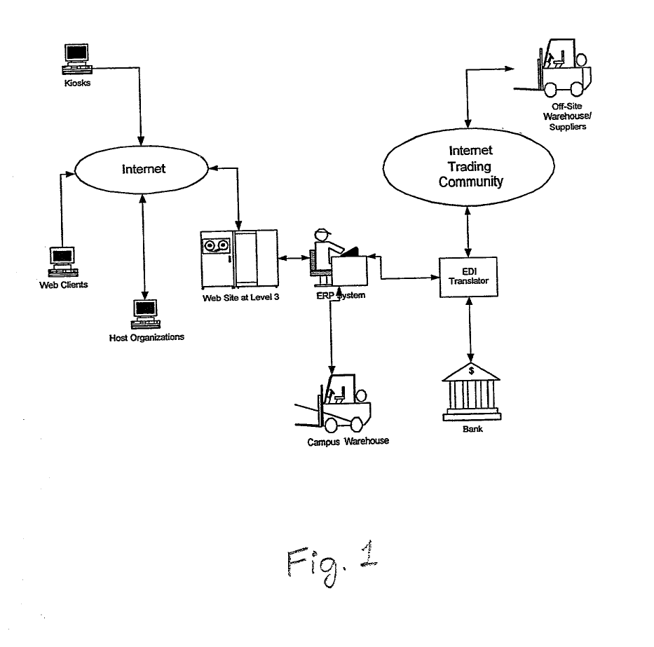

According to the invention, for example as shown in FIG. 1, one or more Internet connected kiosks with touch screens provide Internet shopping access to the individual employees through the use of user accounts, for example payroll, and/or charge accounts. Each of these clients currently employs payroll deduction programs to provide the necessary credit to enable employee/customers to make purchases. To accomplish the purchase and deduction, an existing POS (point of sale) software program may be modified to provide an Internet-assisted, touch screen-operated kiosk, to enable, for example, employees of hospitals, governmental agencies and corporations to purchase a broad assortment of products at their workplace. According to exemplary embodiments, the existing market basket solution has been simplified and uses very large icons adapted to a 17″ monitor. Employees/customers may have the purchase price (i) deducted by their employer over a period of time with no interest or finance charges, or (ii) repaid, without interest, to a house charge account arranged by the provider of the system

This combination creates an e-commerce opportunity that has several distinct advantages over any existing Web site:

1. Its primary customers are motivated primarily by the extension of credit and not price.

2. The customers are available to use the system in large groups and have their employer's endorsement.

3. The installed kiosks with touch screens allow for use by individuals who have no computer training.

4. By expanding the product list to include needed items in addition to desired items, the system can create sales from all of the credit dollars offered to its clients.

5. The system creates a creditworthy receivable from the employer while extending credit and stimulating purchases by the employees. The credit agreement functions like a wage garnishment. If the employee leaves employment, any outstanding balances are deducted from the final paycheck.

6. The system can have a “charge account” accessible at the web site in addition to payroll deduction programs or to customers that do not have payroll deduction. Such a program involves prepaying the interest to the issuer in the form of a discount on advances.

It has been discovered that the principal of payroll deduction may be easily extended to corporations such as employee leasing agencies and personnel agencies. This market also requires less capital expenditure because all that is required is access; while preferable, kiosks are not required as a much greater segment of this marketplace is computer enabled. This gives rise to home use of the present e-commerce model by this group. The economic model is somewhat improved because there are no on site sales to compete for credit limits.

According to exemplary embodiments, a specific credit limit is used with a certain number of paychecks, each having a predetermined deduction. A primary motivation to many of the shoppers using the present system is that the extension of credit is beyond their existing limits.

The present invention further provides an e-commerce model for non-profit institutions such as schools, churches and youth athletic leagues. The present inventive system gives rise to the ability for purchasers to obtain an IRS authorized tax deduction for those people itemizing their deductions.

The e-commerce model on the interactive website allows both inventory and outsourcing of the sold merchandise by the provider of the system. Furthermore, the orders can be linked to other manufacturers such that they ultimately fill the customer's order.

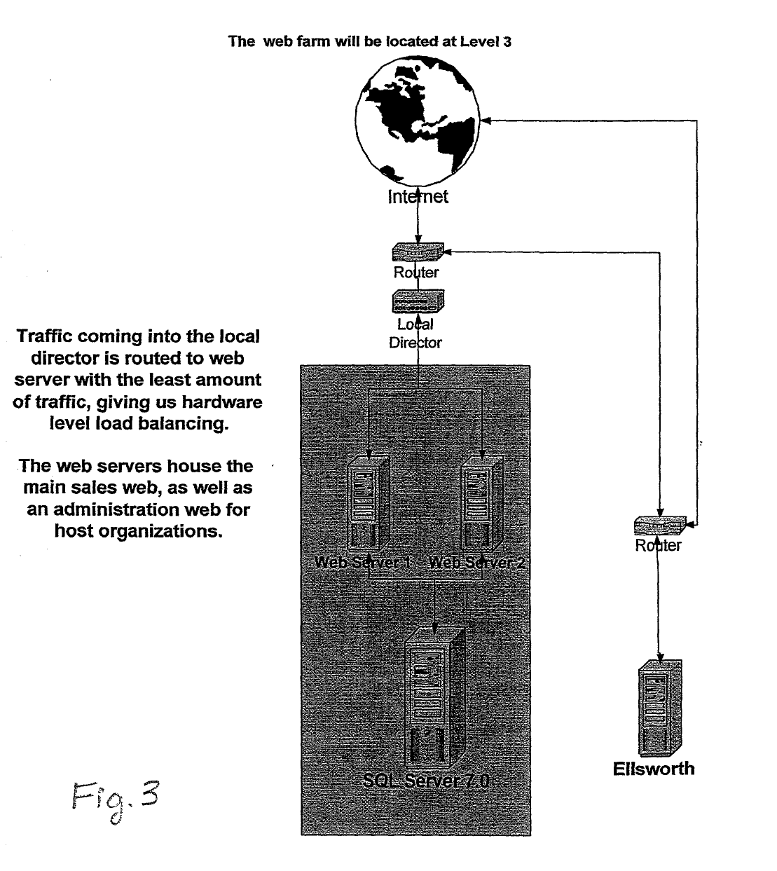

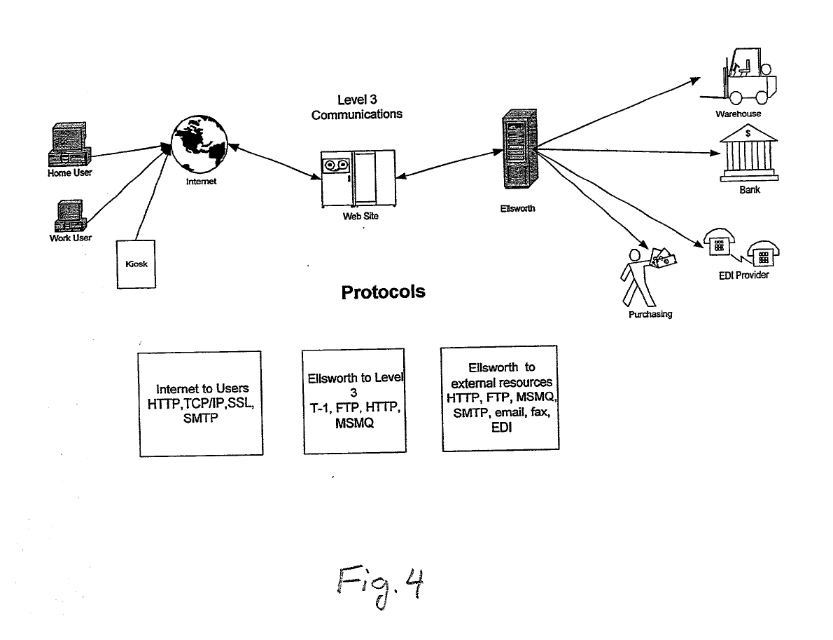

In the embodiment of the present system as is generally shown in FIG. 3, the host website has been designed so that it can be expanded in a parallel fashion such that it can simply bifurcate its data over two or more servers. Furthermore, the telecommunication system backing up the website is Level 3 Communications (FIG. 4) so there will never be a traffic tie up by in-coming calls. The back-office system that integrates the system network server may be, for example, Great Plains. This system accepts the downloaded orders from Objectware's Sequel Server (SQL) and creates picking lists and shipping documents through its interface with shipping companies, such as UPS, USPS and FEDEX software. Furthermore, customers can hyper-link to other websites, select items to be purchased, and bring them back to the host website of the system, thus allowing our customer to purchase using one of the hosts' credit methods.

The operations of present system are particularly suitable for two major business segments: fundraising and employee benefits.

The fundraising segment is designed for all not for profit organizations such as hospitals, labor unions, associations, religious organizations and other affinity groups. Up until now, fundraising has been done by using, for example, jewelry and clothing trunk show sales. Shows of this nature have proven to be successful for the past 15 years and have typically been held two days at a time, twice a year, i.e., four days per year. The shows are directed at the organization's employees.

According to exemplary embodiments, the employees and members of these nonprofit organizations are given access to the host's website either through personal computers and/or the provided system kiosks. For fundraising, 10%-25% of the purchase price of any product gets retained by or paid to the organization. This process allows the purchaser of the products to qualify for and deduct charitable contributions on their personal tax returns, if they itemize their expenses.

The employee benefit segment is designed for all corporations and other for profit organizations. Companies provide employee benefits. Most companies provide health insurance for their employees; many provide pension, profit sharing and 401K plans. All provide these benefits due to desire or requirement. With the rising cost of employee benefits, companies continually look for alternatives and additions to their existing benefit plans. Employees benefit from the extension of interest free credit and the reduction in selling price of the merchandise by virtue of the employer passing on the host fee in the form of a price discount. Thus, the present system provides a very valuable employee benefit with little or no cost to the utilizing organization. In many cases, kiosks do not need to be provided because most companies and their employees have personal computers with Internet access already. In addition, the employee benefit segment serves, in many cases, as a means of funding for employee associations and company sponsored charitable organizations.

In one embodiment, the present inventive system includes one or more kiosks containing a CPU with a hard drive utilizing the Windows operating system. Each kiosk contains a touch screen and a printer. Through a T-1 or T-3 communication line, a network connection provides communication to the host website and preferably one or more file servers. Inventory availability data, client credit files and order entry are resident at the website server. The software resident on the system provides that all credit decisions are automated based on the existing and constantly updated credit file.

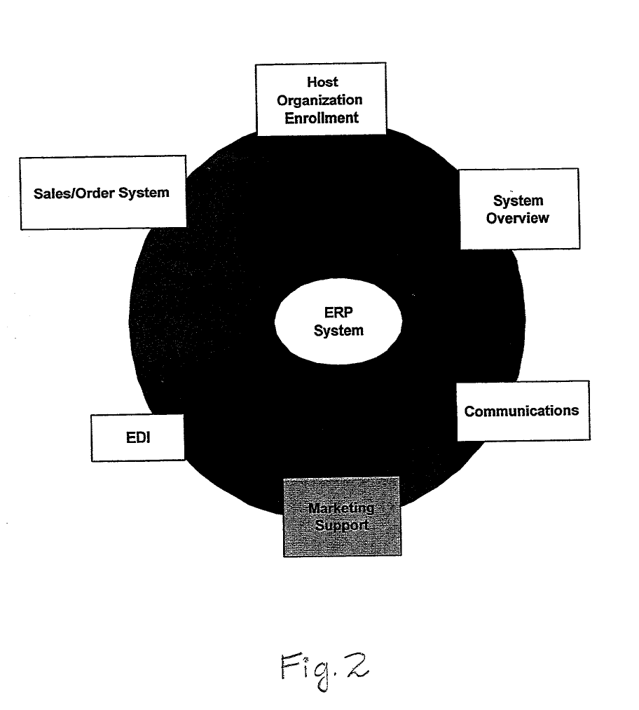

A Kiosk Internet Devise (KID) may be installed in a high traffic area of the facility of the utilizing organization. Inside the KID is a computer processing unit, a screen, an activation device and a printer, all of which are connected via the internet to a web host which is in turn connected via a high capacity electronic connection to the website file server. FIGS. 1-4 illustrate exemplary architecture and data flow from the KID to the host website for the system provider and all the back-office operations of the system.

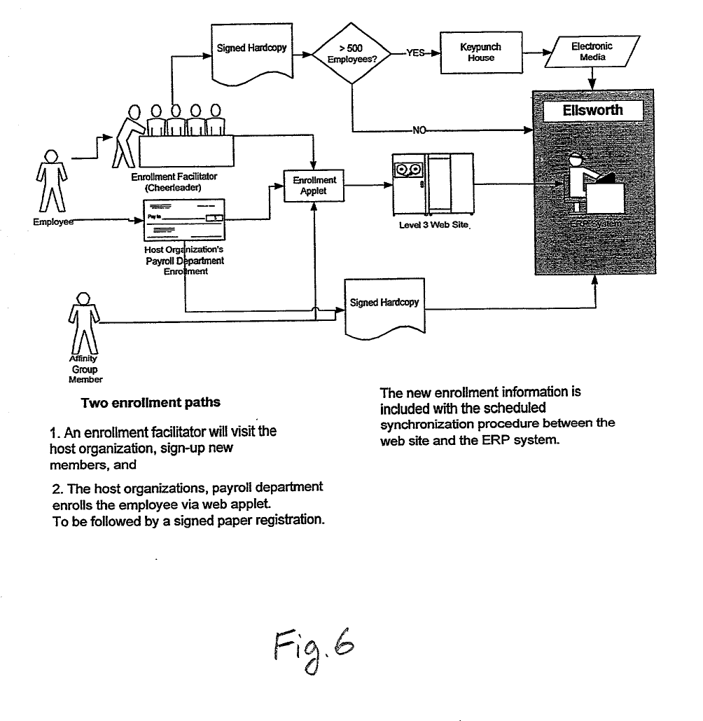

In use, each individual customer enrolls in the program, for example, as shown in FIG. 6, establishing a customer master file containing information such as name, address, phone numbers and social security number. The customer is provided with a Personal Identification Number (PIN) and an individual credit limit and is advised of the applicable number of payroll deductions that will apply. The customer is also given the opportunity to apply for a in-house charge account. A credit file is established for each customer, which is perpetually updated as purchases are made and repayment through payroll deductions or repayment of the in-house charge account occurs. This file is maintained in the system file server, as is other vital information such as available inventory of goods offered for sale. When a customer steps up to the device, he or she must log on using his or her PIN and member number (Social Security Number).

The various databases are continuously synchronized. The customer log on generates a credit request, which through communication with the web host is acknowledged, resulting in a credit authorization. The customer then places a sales order using the KID which is then transmitted to the host website and, in turn, to the system file server.

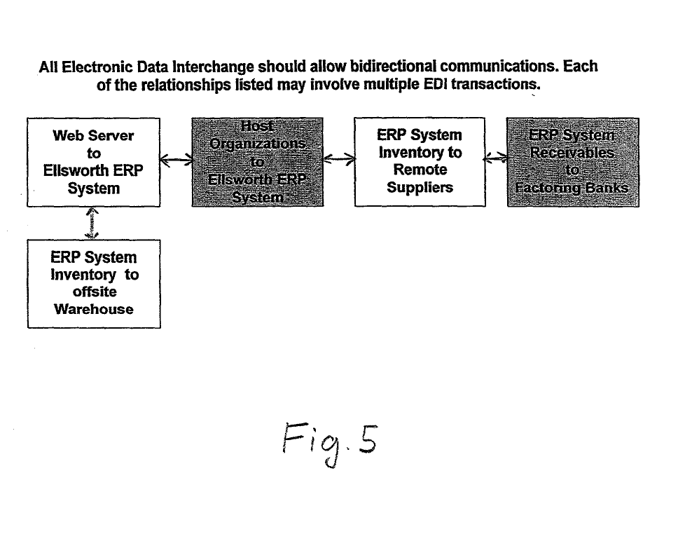

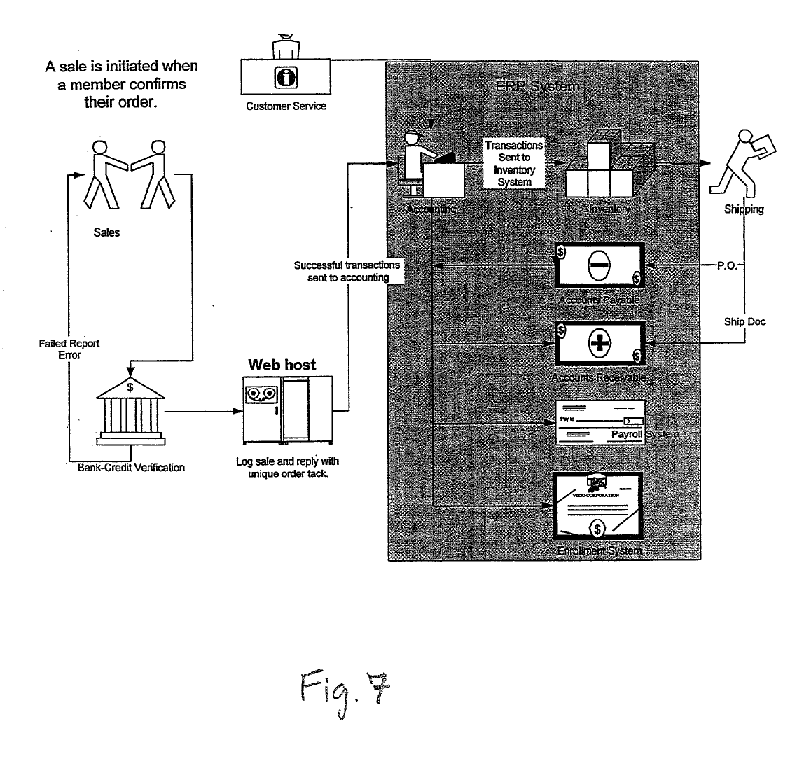

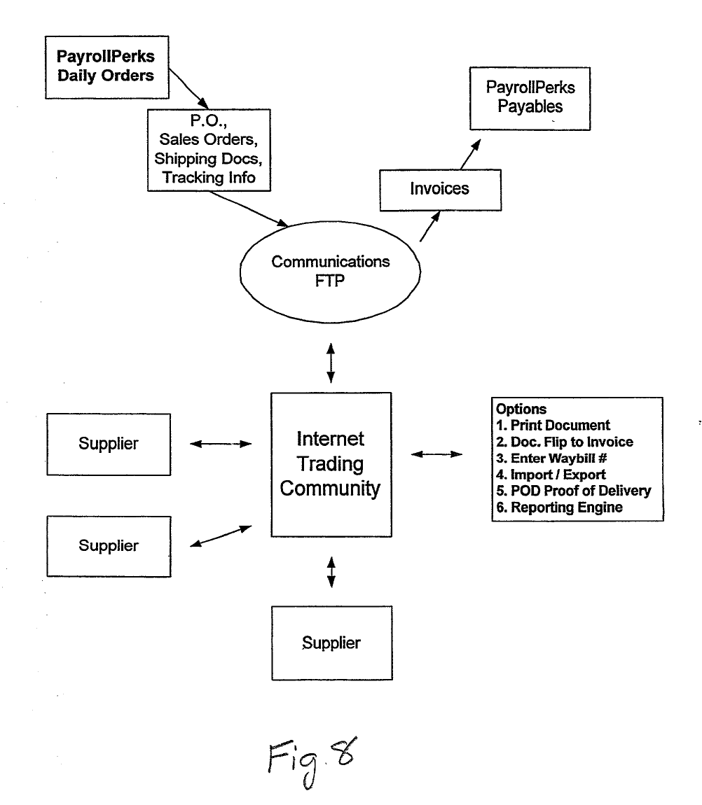

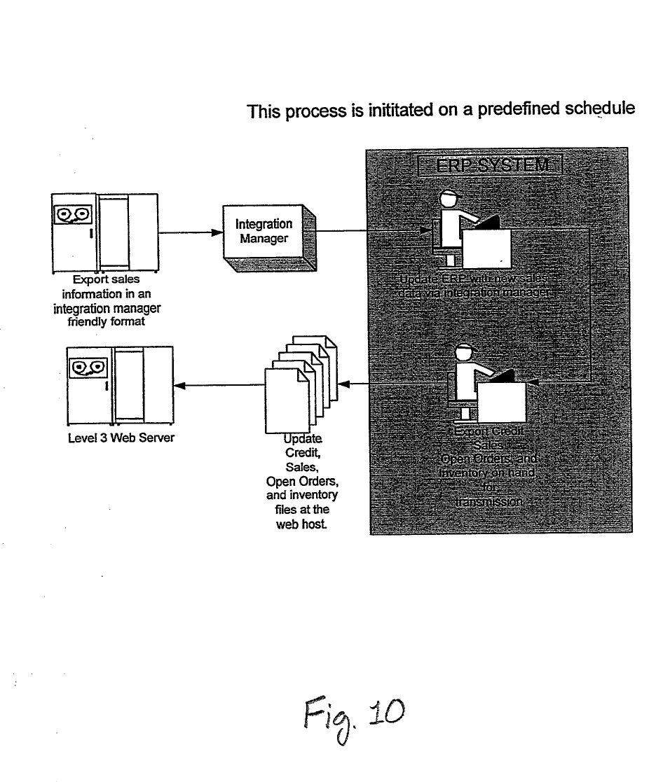

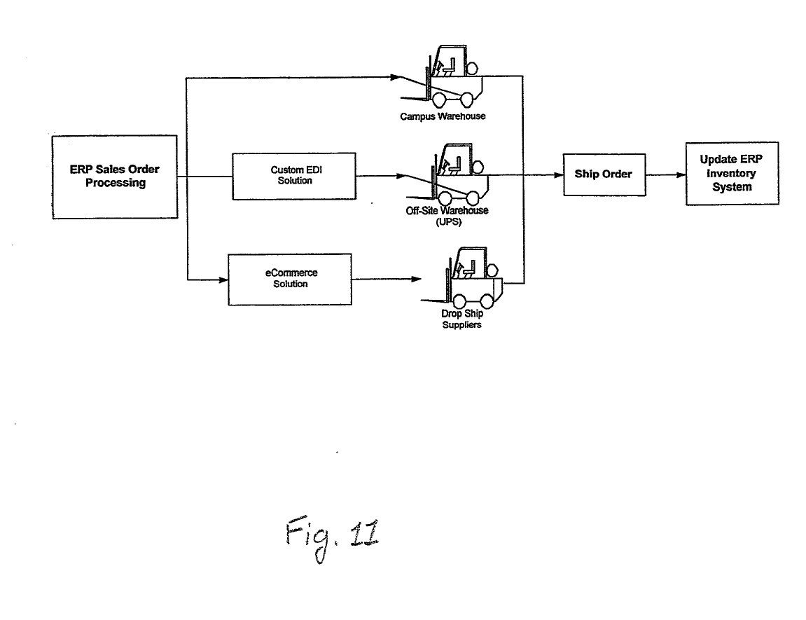

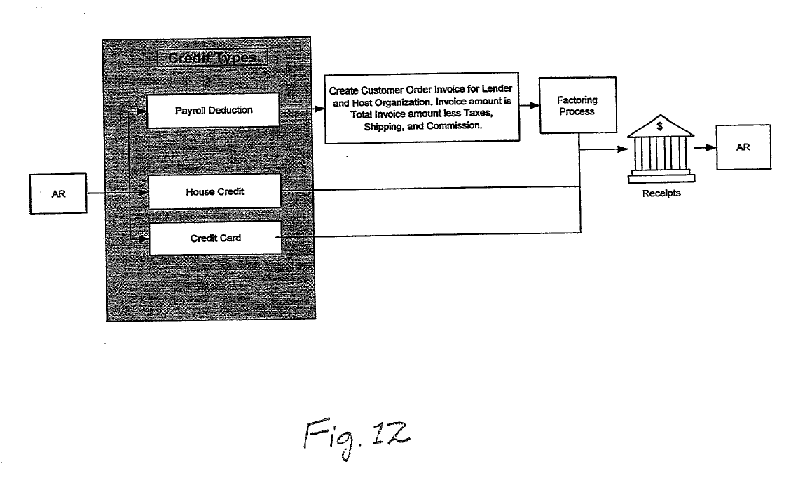

Upon receipt of a sales order, as shown, for example, in FIG. 7, an enterprise resource planning (ERP) system automatically checks for inventory availability from stock, the ERP illustrated in FIGS. 1-13. For purposes of illustration, the ERP is shown at a physical location called “Ellsworth.” If the goods are in local inventory, a pick list is generated, the inventory is reduced, the merchandise is packed and shipped and the sale is recorded. Based upon a predetermined algorithm, the host/sponsor fee and the net receivable are calculated, from which an invoice is generated.

Upon initial receipt of the sales order through payroll deduction, the system may have sold the receivable for which a separate sales order advice was created. The actual invoice may be payable from the employer using the payroll service directly to the holder of the receivable.

If the customer chooses to purchase merchandise with the in-house charge, the receivable is directed to the appropriate finance company, which is responsible for collection from the customer and remittance of cash to the system provider.

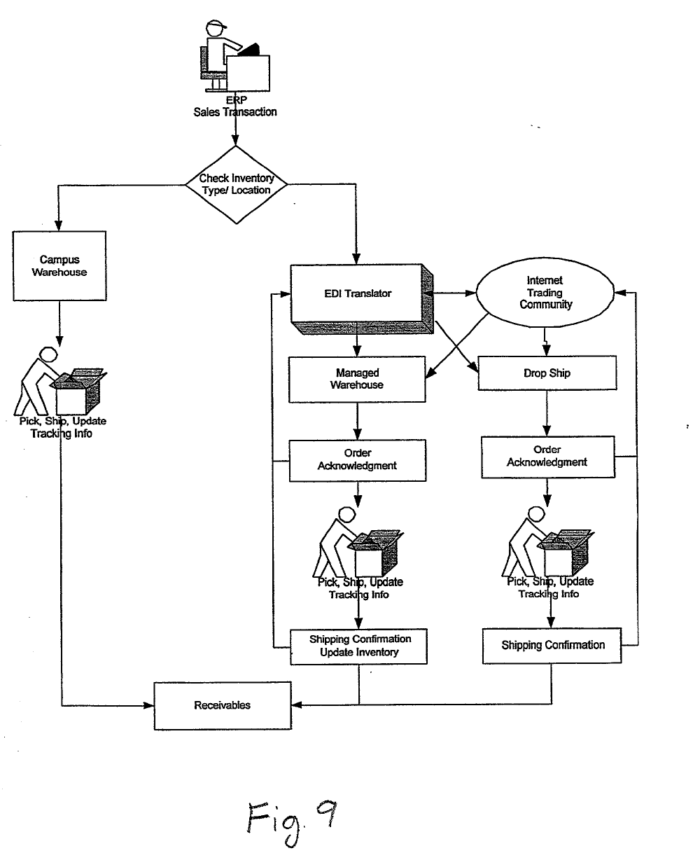

For stock items, the ERP system generates a purchase order whenever the predetermined inventory replenishment level is reached. These are transmitted to the system provider's supplier who, in turn ships the goods. Once the goods are received by the system provider, they are entered into inventory, thereby updating all inventory records and creating an account payable. The process of fulfillment of customer orders is shown in FIG. 9.

In those cases where the system provider chooses not to stock a particular item, the suppliers are instructed to ship the merchandise directly to the customer. Upon confirmation of the shipment the sale is recorded in the normal fashion.

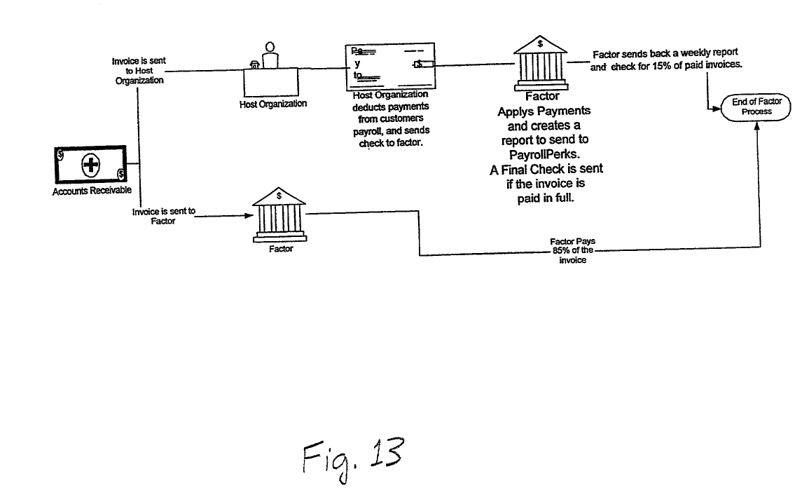

The factor process with accounts receivable is shown in FIG. 13, which illustrates a factor sending 15% of the paid invoices to the service provider. Such illustration further shows the host organization deducting payments from the customer's paychecks and sending a check for the ordered goods and services to the factor.

While there has been shown a preferred embodiment of the present inventive system and method, it should be understood that certain changes may be made in the forms and arrangements of the components and steps of the method without departing from the spirit and scope of the invention as set forth herein.

What is claimed is:

1. A system for facilitating electronic purchasing, the system comprising:
at least one user interface for enabling at least one user to select an item to purchase; and
a processor connected via a network to the user interface for determining available credit limit based upon a user account into which funds are periodically automatically deposited, determining the price of the selected item, comparing the price with the available credit limit, and if the price is less than or equal to the available credit limit, deducting the price from the available credit limit, and automatically deducting funds from the user account at prescribed periods, until the amount of the price has been deducted, wherein as funds are deducted from the user account, the amount of the deducted funds is added to the available credit limit.

2. The system of claim 1, wherein the user account is a payroll, and the funds are automatically deducted from the payroll at each pay period for a predetermined number of pay periods.

3. The system of claim 1, wherein the available credit limit is also determined based on a charge account, and the user designates whether to purchase the item using periodic deductions from the user account or by charging the price to the charge account.

4. The system of claim 3, wherein if the user designates to purchase the item by charging the price to the charge account, the processor deducts the price from the available credit limit, and, upon payment by the user to the charge account, adds the amount of the payment to the available credit limit.

5. The system of claim 1, wherein the processor manages an inventory of items as items are purchased.

6. The system of claim 1, wherein the item is a contribution, good, or service.

7. The system of claim 1, wherein the user interface is a kiosk or a personal computer.

8. The system of claim 1, wherein the processor is a web server.

9. The system of claim 8, wherein the web server is connected to the user interface via the Internet.

10. The system of claim 1, wherein the processor handles a plurality of users, each user having an individual user account, an individual charge account, and an individual available credit limit.

11. A method for facilitating electronic purchasing, the method comprising:
determining the price of an item selected for purchase by a user at a user interface;
determining an available credit limit based upon a user account into which finds are periodically automatically deposited;
comparing the price with the available credit limit;
determining the availability of the item; and
if the price is less than or equal to the available credit limit, deducting the price of the item from the available credit limit, and automatically deducting funds from the user account at prescribed periods until the amount of the price has been deducted, wherein as the finds are deducted from the user account, the amount of the deducted funds is added to the available credit limit.

12. The method of claim 11, wherein the user account is a payroll, and the funds are automatically deducted from the payroll at each pay period for a predetermined number of pay periods.

13. The method of claim 11, wherein the available credit limit is also determined based on a charge account, and the method further comprises the user designating whether to purchase the item using periodic deductions from the user's account or by charging the price to the charge account.

14. The method of claim 13, wherein if the user designates to purchase the item by charging the price to the charge account, the method further comprises deducting the price from the available credit limit, and, upon payment by the user to the charge account, adding the amount of the payment to the available credit limit.

15. The method of claim 11, further comprising managing an inventory of items as items are purchased.

16. The method of claim 11, wherein the item is a contribution, good or service.

17. The method of claim 11, wherein the user interface is a kiosk or a personal computer.

18. The method of claim 11, wherein the steps are performed by a web server.

19. The method of claim 18, wherein the web server is connected to the user interface via the Internet.

20. The method of claim 11, wherein the steps are performed for a plurality of users, each user having an individual user account, an individual charge account, and an individual available credit limit.
